(19) United States
(12) Patent Application Publication
(10) Pub. No.: US 2010/0063780 A1
(43) Pub. Date: Mar. 11, 2010

(54) Measuring Arrangement with Large Dynamic Measuring Range

(75) Inventor: Martin Gehrke, Weinstadt (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Conducta Gesellschaft fur Mess-und Regeltechnik mbH + Co. KG, Gerlingen (DE)

(21) Appl. No.: 12/310,814

(22) PCT Filed: Aug. 31, 2007
(86) PCT No.: PCT/EP2007/059137

§ 371 Date: Nov. 23, 2009

(30) Foreign Application Priority Data
Sep. 8, 2006 (DE) 10 2006 042 807.2

(51) Int. Cl. G06F 15/00; G01J 1/00

(52) U.S. Cl. 702/189; 250/336.1

(57) ABSTRACT

The invention relates to a method for registering a measured variable of a measured medium via a measurement path having a sequence of signals, wherein, apart from an original signal of the sequence, each signal of the sequence is a function of a preceding signal of the sequence, at least one signal of the sequence is transformed as a function of the measured variable by interaction with the measured medium, wherein a time variation is impressed on at least a first signal of the sequence, and a second signal, which is present in the sequence of signals at any location after the first signal, is formed by integration of a signal directly preceding the second signal, wherein, additionally, for ascertaining the measured variable, it is assumed, that the measured variable remains essentially constant during the integration.

The present invention relates to a measuring arrangement for registering a physical variable over a large dynamic range. This is especially important in analytical technology, since, there, effects occur, whose quantitative result extends over many decades.

On the one hand, it is necessary to measure small signals with large resolution and accuracy, and, on the other hand, also to register large signals within the framework of the desired accuracy. For example, in the case of absorption measurements, there is an exponential relationship between the measurement signal and the concentration of an absorbing substance, which caused the measurement signal, and this relationship can easily lead to signals with a dynamic range extending over a number of decades.

When an exciter signal (stimulus) is changed by an analyte, or by a measured medium, and the changed signal is registered as measurement signal, the size of the measurement signal depends on the quantity of the stimulus. An example of this is provided by absorption measurements, in the case of which the measurement signal is essentially proportional to the stimulus, or to the exciter signal. Equally, the signal is proportional to the amplification factor of the sensor circuit, with which the exciter signal changed by the analyte is registered.

For matching the measurement signal to the dynamic range of the measuring circuit, the state of the art provides, for example, that the amplification factor of the sensor circuit or the amplitude of the exciter signal is matched to the influencing of the exciter signal by the analyte.

In order to cover large dynamic ranges, it is known in the state of the art, furthermore, to use amplifiers with logarithmic characteristic curves, circuits with switchable amplifier ranges, or such with different amplifier stages extending in parallel. Selection of the suitable amplifier stage involves identifying the amplifier stage with the currently most favorable signal-to-noise ratio, while taking care not to overdrive the signal.

Furthermore, apparatuses are known having A/D converters of large bit number; however, these are very slow and consume relatively much electrical current. Additionally, they are, in the case of small signals and predetermined absolute resolution, relatively inaccurate as regards the measured values.

An object of the present invention is, therefore, to provide measuring device and measuring method overcoming the described disadvantages of the state of the art.

The object of the invention is achieved by the method as claimed in independent claim 1 and by the measuring device as claimed in independent claim 10.

The method of the invention relates to registering a measured variable of a measured medium over a measurement path involving a sequence of signals, wherein,

apart from an original signal of the sequence, each signal of the sequence is a function of a preceding signal of the sequence,

at least one signal of the sequence is transformed as a function of the measured variable by interaction with the measured medium,

wherein, additionally, a time variation is impressed on at least a first signal of the sequence, and

a second signal, which is present in the sequence of signals at any location after the first signal, is formed by integration of a signal directly preceding the second signal,

wherein, additionally, for ascertaining the measured variable, it is assumed, that the measured variable is essentially constant during the integration.

The time variation of the first signal can be, for example, a strictly monotonic function of time, especially a linear function.

The first signal can be formed, for example, by integration of a constant signal by means of an integrator circuit, with the constant signal being, for example, the original signal of the sequence.

In ascertaining a measured value, the first signal starts, preferably, from a fixed starting value, especially zero, and rises steadily during the measuring.

The integration for ascertaining the second signal is started, preferably, with a fixed time relationship to the variation of the first signal, especially simultaneously.

For determining the measured value, integration can be performed, for example, until the second signal reaches a reference value, wherein the measured value can then be derived from the integration time required to reach the reference value. This embodiment of the invention is currently preferred; it assumes, naturally, that the second signal already depends on the measured variable, and, thus, is in the measurement path at any location after the interaction of a signal with the measured medium.

The first signal, in a currently preferred embodiment of the invention, is independent of the measured variable; it is in the measuring chain, thus, before the signal transformed by interaction with the measured medium.

In a second embodiment of the invention, also the first signal in the measuring chain can be located after the signal, which depends on the signal transformed by interaction with the measured medium. In this case, the first signal is already measured-value dependent, with the time variation being impressed essentially independently of the measured variable.

In a third embodiment of the invention, also the second signal in the measuring chain can be arranged before the signal transformed by interaction with the measured medium. In this case, the second signal is independent of the measured variable. Instead, the signal, which is transformed by interaction with the measured medium, has a time dependence of higher order. The measured variable can, in this case, be ascertained by ascertaining the time passing until a signal depending from the signal transformed by interaction with the measured medium moves beyond a limit value.

The measuring device of the invention for registering a measured variable of a measured medium includes a measurement path having a sequence of signals, wherein,

apart from an original signal of the sequence, each signal of the sequence is a function of a preceding signal of the sequence, and

at least one signal of the sequence is transformed by interaction with the measured medium,

wherein the measuring device additionally includes a first circuit for impressing a time variation on the first signal, and

a second circuit for providing a second signal present in the sequence of signals at any location after the first signal, wherein the second circuit integrates a signal of the sequence and outputs the integral as the second signal.

In a currently preferred embodiment of the measuring device, the first circuit includes

either an exciter circuit for output of a time-variable exciter signal, which enters directly into interaction with the measured medium, or

a driver circuit for output of a time-variable driver signal, which drives an exciter signal, which enters directly into interaction with the measured medium,

wherein the measuring device additionally includes:

A sensor for receiving a response signal arising from interaction of the exciter signal with the measured medium, wherein the sensor provides an electrical, primary signal, which depends on the response signal, and

a measuring circuit, which processes the primary signal into a measurement signal, wherein the measuring circuit contains the second circuit, which integrates the primary signal or a signal dependent thereon, in order to provide the second signal.

Preferably, the measuring circuit ascertains the integration time required for the second signal to reach a threshold value, and determines, on the basis of the integration time, a current measured value of the measured variable.

The measuring circuit for ascertaining the integration time can include a clocked counter, which is started with the beginning of the integration, and stopped upon the reaching of the threshold.

The measuring circuit can furthermore include a comparator circuit, in order to monitor the reaching of the threshold.

The exciter signal can comprise, for example, an electromagnetic wave, especially light, including IR and UV, radiated into a measured medium or interacting evanescently with the measured medium. The response signal can, accordingly, be a signal arising from any interactive processes with the measured medium, for example, attenuation, scatter, absorption and emission. The sensor can be, accordingly, for example, a suitable photocell or a heat sensor.

The invention will now be explained on the basis of examples of embodiments presented in the drawings, the figures of which show as follows:

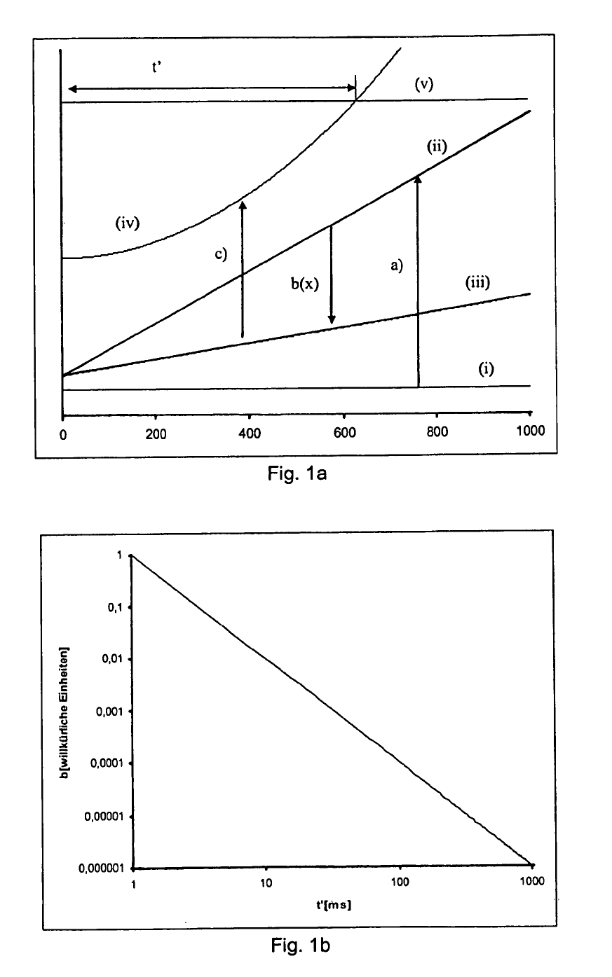

FIG. 1a a diagram, as a function of time, of various signals of the measuring chain of an example of an embodiment of the method of the invention;

FIG. 1b a diagram illustrating benefit of the method of the invention;

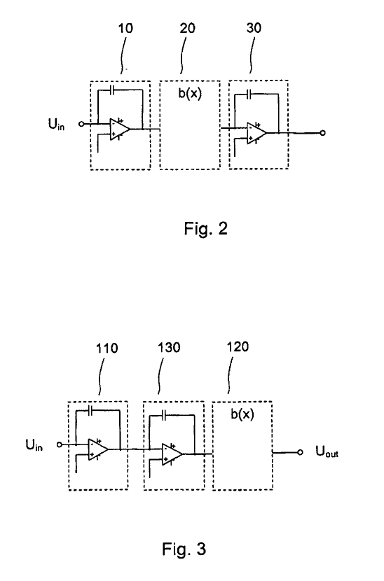

FIG. 2 a block diagram for a first embodiment of a measurement path of an apparatus of the invention;

FIG. 3 a block diagram for a second embodiment of a measurement path of an apparatus of the invention; and

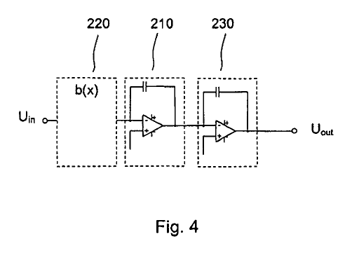

FIG. 4 a block diagram for a third embodiment of a measurement path of an apparatus of the invention.

FIG. 1a shows, as a function of time, signals of a measurement path for performing the method of the invention for one integration cycle. A constant supply voltage (i) is converted in a first integration step (a) into a first signal (ii) rising linearly in time. This first signal can be, for example, the supply voltage of a light source, which emits an exciter signal proportional to (ii) into a measured medium. For purposes of not cluttering the diagram, it has been so scaled, that the intensity of the exciter signal is, likewise, represented by (ii). Through the interaction, b(x), with the measured medium, there is received from the medium a response signal attenuated relative to the exciter signal (ii). The response signal is converted by a sensor, for example, a photocell, into a primary signal (iii). For simplicity, it is again assumed, the primary signal (iii) is so scaled, that, in the case of a measured medium without attenuation, it coincides with the signal (ii). The primary signal (iii) is converted via a second integration step (c) into the integral (iv), which rises quadratically as a function of time. For ascertaining the measured value of the measured variable, which, here, is contained in the attenuation b(x), the integration time is ascertained, which is required, until the integral (iv) reaches a threshold value (v).

The slope of the curve (iii) in FIG. 1a, which depends on the attenuation b(x), is proportional to (1/t′)̂2. According to FIG. 1b, the value of the slope of the curve (iii) over a dynamic range of six orders of magnitude can be registered with a time measurement, or counter, over three orders of magnitude.

The measurement path of a measuring device according to a currently preferred embodiment of the invention is presented schematically in FIG. 2. A driver circuit includes an integrator 10, which integrates a constant input voltage Uᵢₙ. The integrated voltage signal on the output of the integrator 10 is output as driver signal, which, over a measuring cycle for registering a measured value, rises linearly, starting from the starting value, “zero”. The driver signal controls, or supplies, for example, a light source, which, in a central section 20 of the measurement path, emits light, as exciter signal, into the measured medium. From the measured medium arises a weakened light signal as response signal. This weakened response signal, or the ratio between the exciter signal and the response signal, b(x), then contains the media-specific information. The response signal is converted by a sensor into an electrical, primary signal, which is integrated by means of a second integrator 30. The output voltage of the second integrator Uₒᵤₜ is fed to a comparator (not shown), which compares Uₒᵤₜ with a threshold value. With the start of an integration, a counter (not shown) is started, which is stopped by means of the comparator circuit upon reaching the threshold. From the counter reading, which is a measure for the integration time, b(x), and, therewith, the measured value of the measured variable of interest, can be ascertained.

Following reaching of the threshold and the read-out of the counter, the two integrators discharge and the counter is reset to zero, in order to start the registering of next measured value.

FIG. 3 shows a further embodiment of a measurement path of the invention, wherein, here, the first integrator 110 and the second integrator 130 are connected in front of the exciter signal. In this way, the exciter signal radiated into the medium in a measured media section 120 of the measurement path already has a quadratic time dependence, which, naturally, leads to a quadratic time dependence of the response signal and of the primary signal of the sensor. The primary signal, or a signal Uₒᵤₜ dependent therefrom, can, without further integration, be fed to a comparator, which monitors the reaching of a threshold.

In the embodiment in FIG. 4, by means of a constant input voltage Uᵢₙ, there is driven, during the determining of a measured value, a constant exciter signal, which is radiated into the measured medium in a measured media section 220 of the measurement path. Accordingly, the response signal and the primary signal of a sensor for registering a response signal exhibit no time dependence impressed by the measuring apparatus. The primary signal is then sent through a sequence of a first integrator 210 and a second integrator 230, so that the output signal Uₒᵤₜ again has a quadratic time dependence. The measured value ascertainment is then accomplished, such as was above described, via the time required for reaching a threshold value.

1-16. (canceled)

17. A method for registering a measured variable of a measured medium via a measurement path having a sequence of signals, wherein, apart from an original signal of the sequence, each signal of the sequence is a function of a preceding signal of the sequence, comprising the steps of:
at least one signal of the sequence is transformed as a function of the measured variable by interaction with the measured medium;
impressing a time variation on at least a first signal of the sequence; and
forming a second signal, which is present in the sequence of signals at any location after the first signal, by integration of a signal directly preceding the second signal, wherein:
for ascertaining the measured variable, it is assumed, that the measured variable remains essentially constant during the integration.

18. The method as claimed in claim 17, wherein:
the time variation of the first signal during registering of a measured value is a strictly monotonic function, especially a linear function, of time.

19. The method as claimed in claim 18, wherein:
the first signal is formed by integration of a constant signal by means of an integrator circuit.

20. The method as claimed in claim 17, wherein:
the first signal, upon beginning ascertaining of a measured value, starts from a fixed starting value, especially zero, and rises steadily during measuring.

21. The method as claimed in claim 17, wherein:
integration for ascertaining the second signal is started at a fixed time relationship to the variation of the first signal, especially simultaneously.

22. The method as claimed in claim 17, wherein:
the second signal depends on the measured variable, and, thus, follows in the measurement path at any location after the interaction of a signal with the measured medium;
for ascertaining the measured value, the integration for determining the second signal continues, until the second signal reaches a reference value; and
the measured value is derived, then, from the integration time required to reach the reference value.

23. The method as claimed in claim 17, wherein:
the first signal is independent of the measured variable, and is, thus, present in the measuring chain before the signal transformed by interaction with the measured medium.

24. The method as claimed in claim 17, wherein:
the first signal is located in the measuring chain after the signal transformed by interaction with the measured medium.

25. The method as claimed in claim 17, wherein:
the second signal is located in the measuring chain before the signal transformed by interaction with the measured medium.

26. A measuring device for registering a measured variable of a measured medium, comprising:
a measurement path having a sequence of signals, wherein, apart from an original signal of the sequence, each signal is a function of a preceding signal of the sequence, and at least one signal of the sequence is transformed by interaction with the measured medium;
has a first circuit for impressing a time variation on a first signal of said sequence; and
a second circuit for providing a second signal, which is present in said sequence of signals at any location after said first signal, wherein:
said second circuit integrates a signal of said sequence and outputs the integral as said second signal.

27. The measuring device as claimed in claim 26, wherein:
said first circuit includes an exciter circuit for outputting a time-variable exciter signal, which interacts directly with the measured medium.

28. The measuring device as claimed in claim 26, wherein:
said first circuit includes a driver circuit for outputting a time-variable driver signal, which drives an exciter signal, which interacts directly with the measured medium.

29. The measuring device as claimed in claim 27, further comprising:
a sensor for receiving a response signal, which arises from interaction of said exciter signal with the measured medium, wherein:
said sensor provides an electrical, primary signal, which depends on said response signal.

30. The measuring device as claimed in claim 26, further comprising:
a measuring circuit, which processes said primary signal to a measurement signal, wherein:
said measuring circuit includes said second circuit, which integrates said primary signal or a signal dependent thereon, in order to provide said second signal.

31. The measuring device as claimed in claim 30, wherein:
said measuring circuit registers integration time required for said second signal to reach a threshold value, and a current measured value of the measured variable is ascertained based on the integration time.

32. The measuring device as claimed in claim 26, wherein:
said exciter signal is an electromagnetic wave, especially light, radiated into a measured medium or interacting evanescently with the measured medium via an interface.
